(19) United States
(12) Patent Application Publication
(10) Pub. No.: US 2019/0006089 A1
(43) Pub. Date: Jan. 3, 2019

(54) ELECTRONIC DEVICE

(71) Applicant: TDK CORPORATION, Tokyo (JP)

(72) Inventor: Takashi KUDO, Tokyo (JP)

(73) Assignee: TDK CORPORATION, Tokyo (JP)

(21) Appl. No.: 16/014,101

(22) Filed: Jun. 21, 2018

(30) Foreign Application Priority Data
Jun. 30, 2017 (JP) 2017-129424

(51) Int. Cl. H01F 27/29; H01F 17/00; H01F 27/28; H01F 5/00

(52) U.S. Cl. CPC H01F 27/292; H01F 5/003; H01F 27/2804; H01F 17/0013

(57) ABSTRACT

An electronic device includes a component body and a terminal electrode formed on a mounting surface of the component body. The chamfered part is formed at an intersection between the mounting surface and a side surface of the component body. An edge of the terminal electrode becomes thinner toward the chamfered part.

### BACKGROUND OF THE INVENTION

### 1. Field of the Invention

The present invention relates to an electronic device used as a chip component.

### 2. Description of the Related Art

In an electronic device such as a chip component, a terminal electrode is formed continuously even on a side surface together with a mounting surface, in order to form a solder filet on the side surface of the terminal electrode.

In this type of electronic devices, however, if the electronic devices adjacent to each other are arranged closely in high-density mounting or so, solder reaches between the electronic devices adjacent to each other, and solder bridge is thereby easy to occur. Thus, short circuit failure may occur between the electronic devices adjacent to each other.

On the other hand, Patent Document 1 discloses that a terminal electrode is formed only on a mounting surface in the multilayer coil device. Thus, short circuit failure can be prevented from occurring between the electronic devices adjacent to each other.

In the multilayer coil device of Patent Document 1, however, the terminal electrode is formed away from a side surface of an element body, a sufficient area of the terminal electrode cannot be secured, and mounting strength may decrease.

Patent Document 1: JP2013211302 (A)

### SUMMARY OF THE INVENTION

The present invention has been achieved under such circumstances. It is an object of the invention to provide an electronic device excellent in high-density mounting while a sufficient area of a terminal electrode is secured.

To achieve the above object, an electronic device according to the present invention comprises:

a component body; and

a terminal electrode formed on a mounting surface of the component body,

wherein a chamfered part is formed at an intersection between the mounting surface and a side surface of the component body, and

wherein an edge of the terminal electrode becomes thinner toward the chamfered part.

In the electronic device according to the present invention, the chamfered part is formed at the intersection between the mounting surface and the side surface of the component body, and the edge of the terminal electrode becomes thinner toward the chamfered part. That is, the edge of the terminal electrode is chamfered integrally with the intersection between the mounting surface and the side surface of the component body in forming the chamfered part in the present invention. Thus, the edge of the terminal electrode is arranged inside the side surface of the component body and is smoothly (continuously) connected with the chamfered surface of the chamfered part while being gently curved. During high-density mounting, it thereby becomes harder for solder to protrude outward from the component body and to reach between the electronic devices adjacent to each other, compared to prior arts. Thus, it is possible to effectively prevent generation of solder bridge between the terminal electrodes adjacent to each other and to effectively prevent generation of short circuit failure between the terminal electrodes adjacent to each other. Since the edge of the terminal electrode reaches near the chamfered part, it is possible to secure a sufficient area of the terminal electrode and to secure an excellent mounting strength even if a chip size is small.

The chamfered part may be an R-plane or a C-plane depending on required standard, usage, and the like.

To achieve the above object, a method of manufacturing the electronic device according to the present invention comprises the steps of:

obtaining a component body containing an element so that at least a part of a lead is exposed;

forming a terminal electrode even near a side surface of the component body on a mounting surface of the component body so that the terminal electrode is connected with at least a part of the lead exposed from the component body; and

forming a chamfered part at an intersection between the mounting surface and the side surface of the component body.

In the method of manufacturing the electronic device (chip component), a step of forming the terminal electrode on the component body is normally carried out after a step of forming the chamfered part on the component body. In the present invention, however, a step of forming the chamfered part on the component body is carried out after a step of forming the terminal electrode on the component body. In the method according to the present invention, the edge of the terminal electrode is chamfered together with the intersection between the mounting surface and the side surface of the component body in forming the chamfered part. Thus, it is possible to easily manufacture pieces of the electronic device where the edge of the terminal electrode becomes gradually thinner toward the chamfered part.

To achieve the above object, a method of manufacturing the electronic device according to the present invention comprises the steps of:

obtaining a substrate containing a plurality of elements so that at least a part of a lead is exposed;

forming a terminal electrode in a predetermined pattern on one of surfaces of the substrate so that the terminal electrode is connected with at least a part of the lead exposed from the substrate;

cutting the substrate with the terminal electrode so that the predetermined pattern is cut; and

forming a chamfered part at an intersection between a mounting surface and a side surface of the cut substrate.

In the method according to the present invention, the edge of the terminal electrode is chamfered together with the intersection between the mounting surface and the side surface of the cut substrate in forming the chamfered part. Thus, it is possible to easily manufacture an aggregation of the electronic device where the edge of the terminal electrode gradually becomes thinner toward the chamfered part. The terminal electrode pattern does not attach to each cut surface of the aggregation of the electronic device, and it is possible to manufacture the electronic device with the terminal electrode formed only on the mounting surface.

### BRIEF DESCRIPTION OF THE DRAWINGS

FIG. 1A is a perspective view of an electronic device according to an embodiment of the present invention.

FIG. 1B is a plane view of the electronic device.

FIG. 1C is a cross-sectional view of the electronic device mounted on a circuit board.

FIG. 1D is a partially enlarged cross-sectional view of the electronic device along the ID-ID line shown in FIG. 1A.

FIG. 1E is a partially enlarged cross-sectional view of the electronic device along the IE-IE line shown in FIG. 1A.

FIG. 1F is a perspective view of a variation of the electronic device shown in FIG. 1A.

FIG. 2A is a perspective view showing a process of manufacturing the electronic device.

FIG. 2B is a perspective view showing a next step of FIG. 2A.

FIG. 2C is a perspective view showing a next step of FIG. 2B.

FIG. 2D is a perspective view showing a next step of FIG. 2C.

### DETAILED DESCRIPTION OF THE PREFERRED EMBODIMENT

Hereinafter, the present invention is described based on an embodiment shown in the figures.

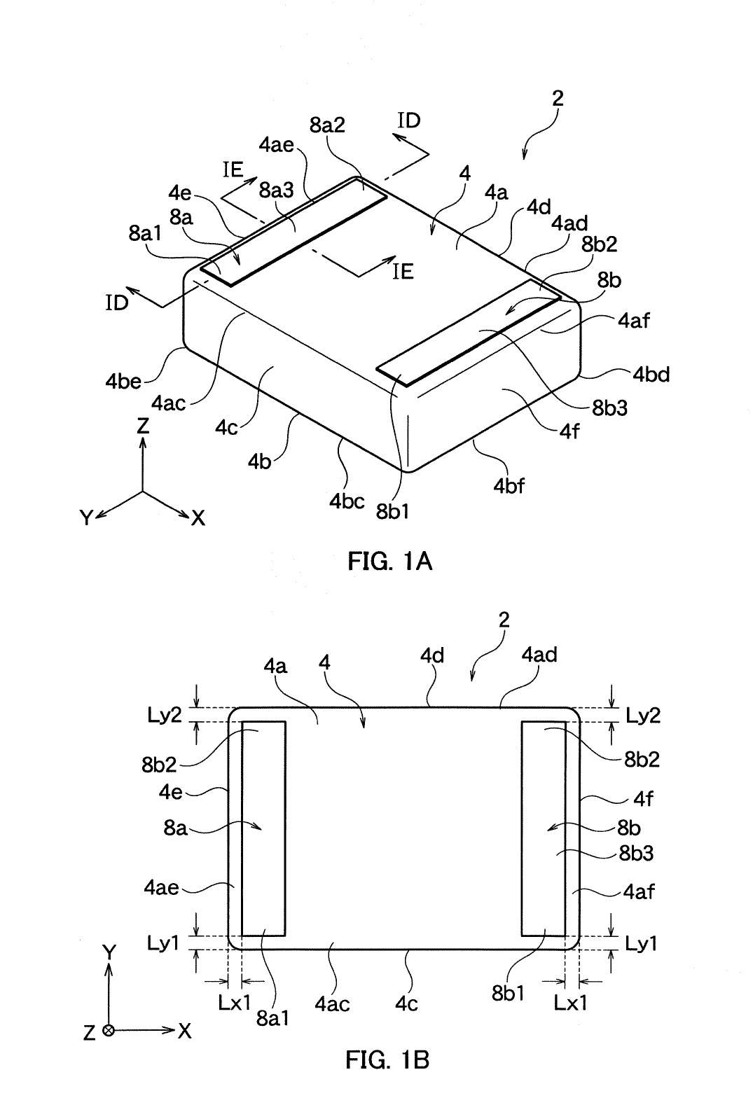

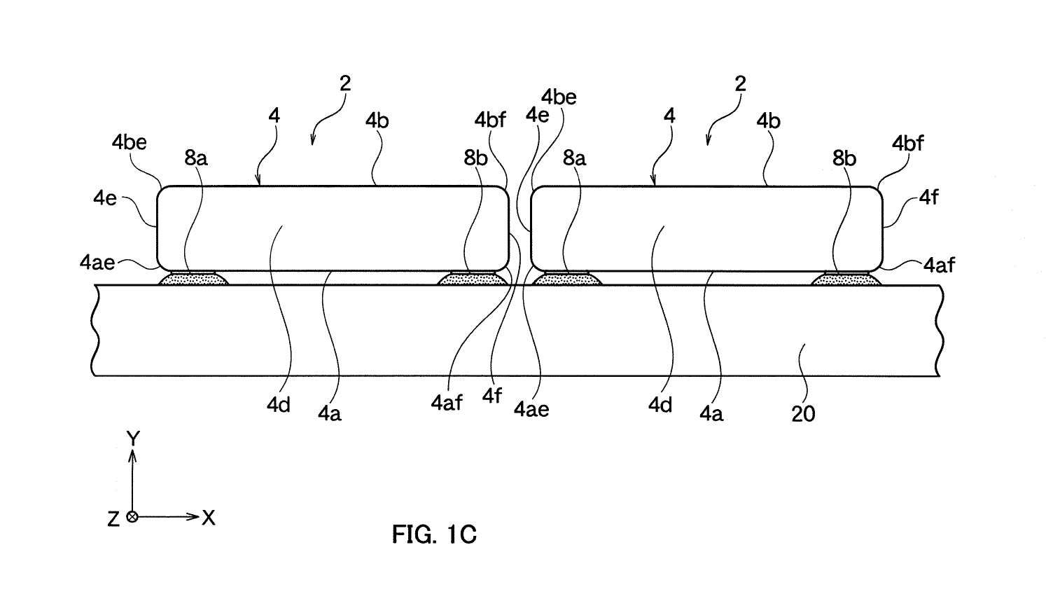

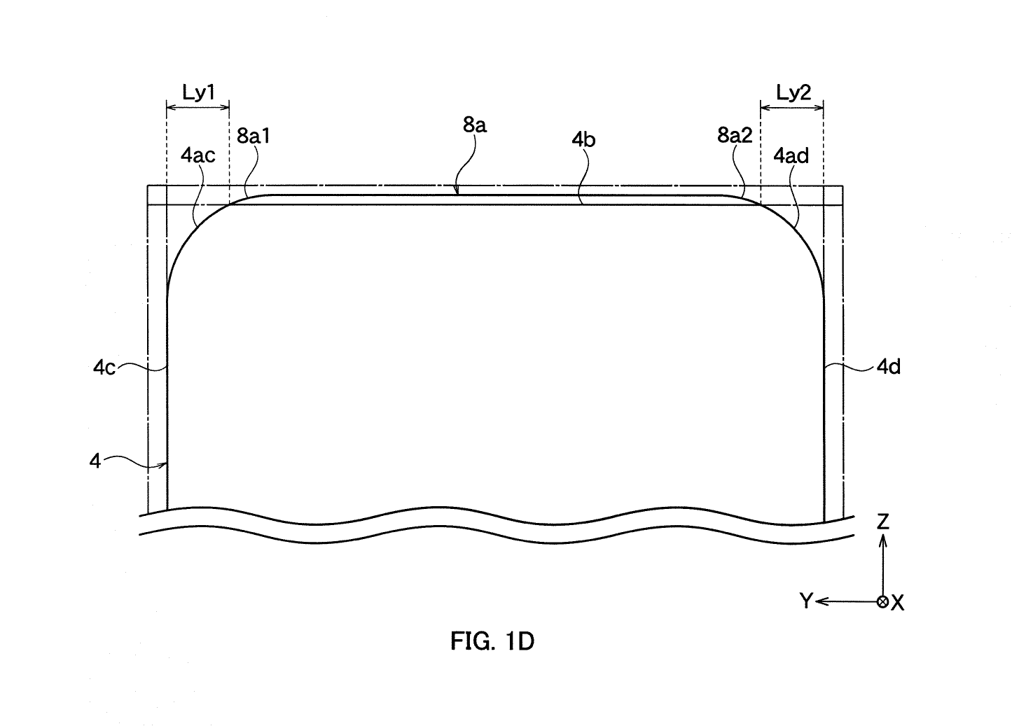

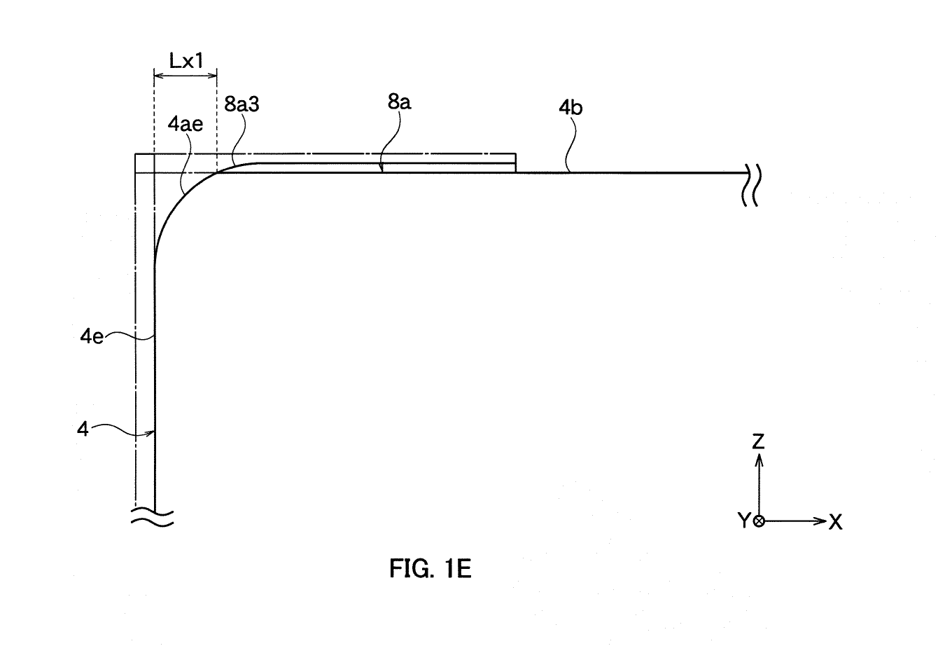

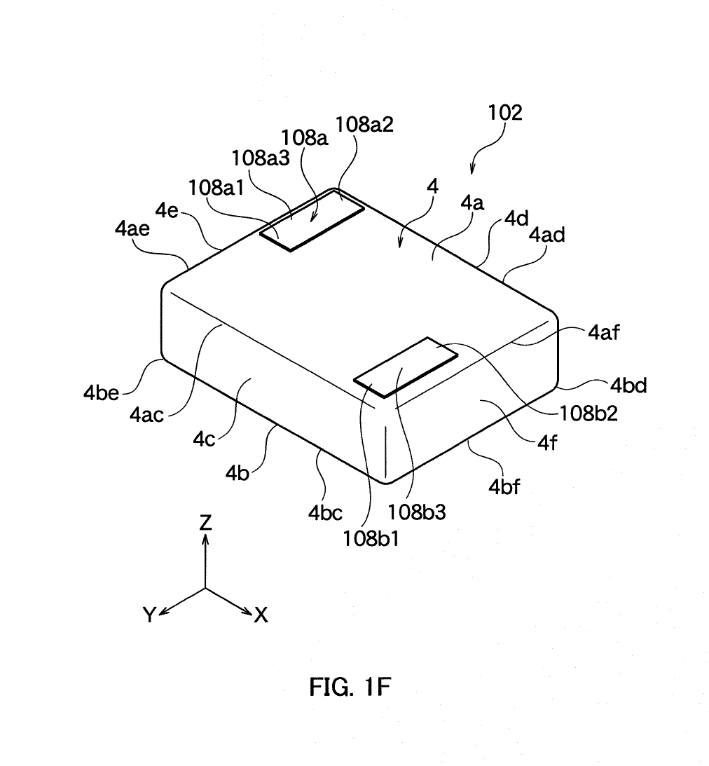

As shown in FIG. 1A, an inductor 2 as an electronic device (chip component) according to an embodiment of the present invention has a component body (element body) 4 having an approximately rectangular-parallelopiped shape (approximately hexahedron shape). Incidentally, the electronic device of the present invention is not limited to the inductor 2, but may be another coil device, a capacitor, a resistor, a noise filter, a transformer, a chip component, or the like.

The component body 4 has a mounting surface 4a, a rear surface 4b opposite to the mounting surface 4a in the Z-axis direction, and four side surfaces 4c to 4f. The component body 4 has any size. For example, the component body 4 preferably has a length (X-axis) of 1.4 to 6.5 mm, preferably has a width (Y-axis) of 0.6 to 6.5 mm, and a height (Z-axis) of 0.5 to 5.0 mm.

In the present embodiment, as shown in FIG. 1A and FIG. 1C, chamfered parts 4ac, 4ad, 4ae, and 4af are formed respectively at intersections (corners) between the mounting surface 4a and the side surfaces 4c, 4d, 4e, and 4f of the component body 4. The chamfered parts 4ac to 4af are formed by R-planes (rounded), but may be formed by C-planes depending on required standard, usage, and the like. Preferably, chamfered surfaces of the chamfered parts 4ac to 4af have a curvature radius of 0.03 to 0.20 mm. Incidentally, the chamfered parts 4ac to 4af formed by C-planes have a chamfer width appropriately determined so that an outer shape similar to that of the chamfered parts 4ac to 4af formed by R-planes is obtained.

Likewise, chamfered parts 4bc, 4bd, 4be, and 4bf are formed respectively at intersections (corners) between the rear surface 4b and the side surfaces 4c, 4d, 4e, and 4f of the component body 4. The chamfered parts 4bc to 4bf are formed by R-planes (rounded), but may be formed by C-planes depending on required standard, usage, and the like.

In the present embodiment, the component body 4 is composed of a synthetic resin where ferrite particles or metal magnetic particles are dispersed, but may be composed of a synthetic resin that does not contain ferrite particles or metal magnetic particles. The ferrite particles are Ni—Zn based ferrite, Mn—Zn based ferrite, or the like. The metal magnetic particles are not limited, and are Fe—Ni alloy powder, Fe—Si alloy powder, Fe—Si—Cr alloy powder, Fe—Co alloy powder, Fe—Si—Al alloy powder, or the like.

The synthetic resin contained in the component body 4 is not limited, but is preferably an epoxy resin, a phenol resin, a polyester resin, a polyurethane resin, a polyimide resin, or the like.

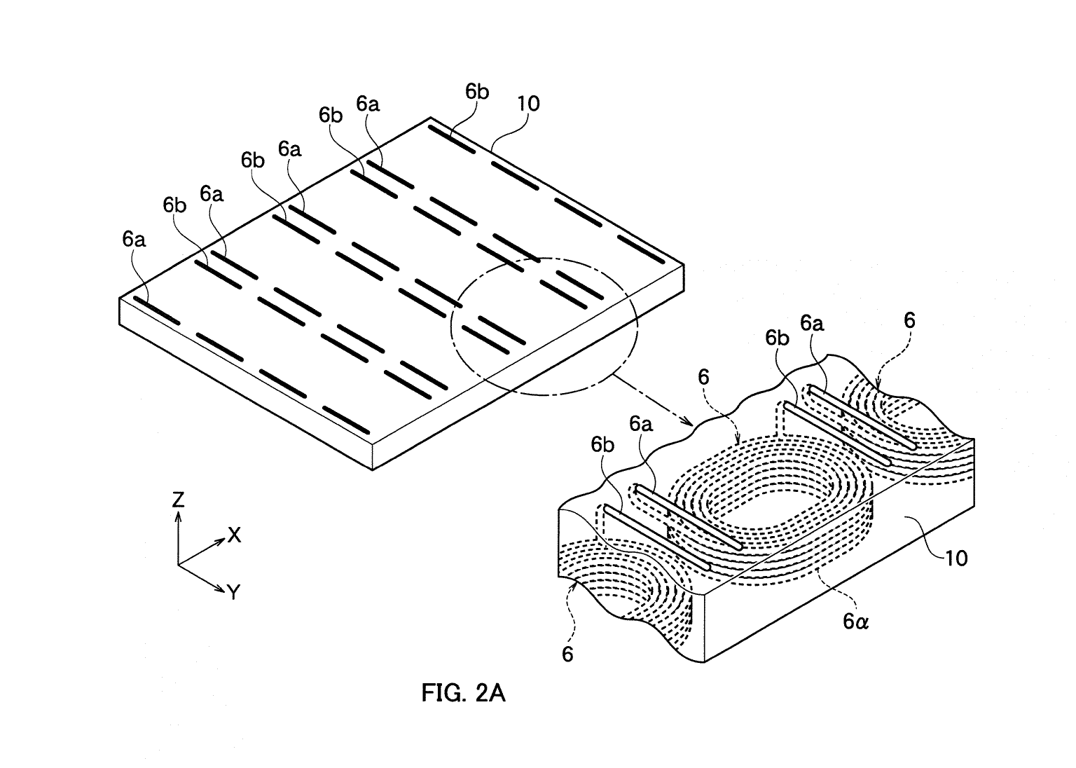

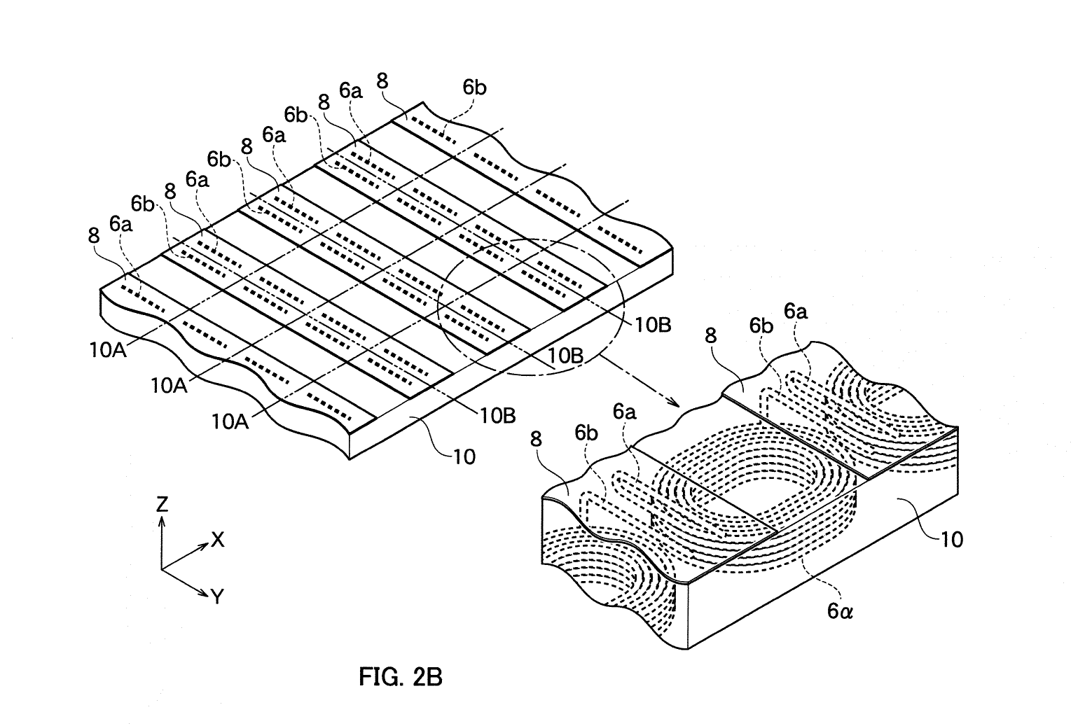

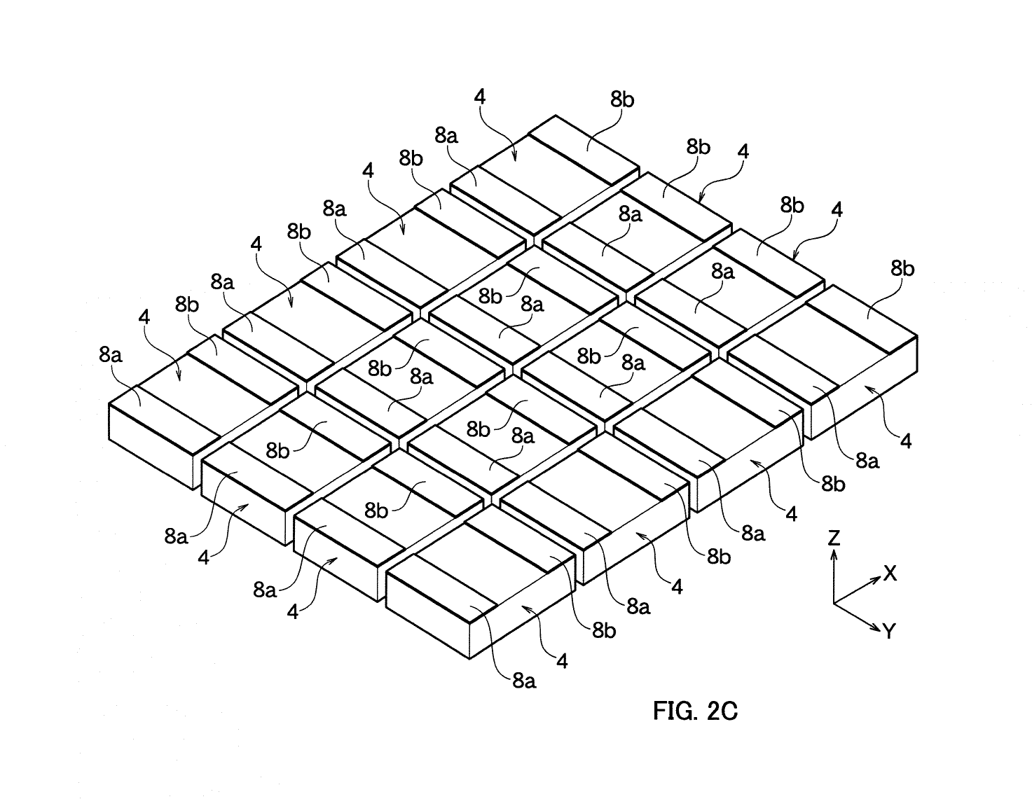

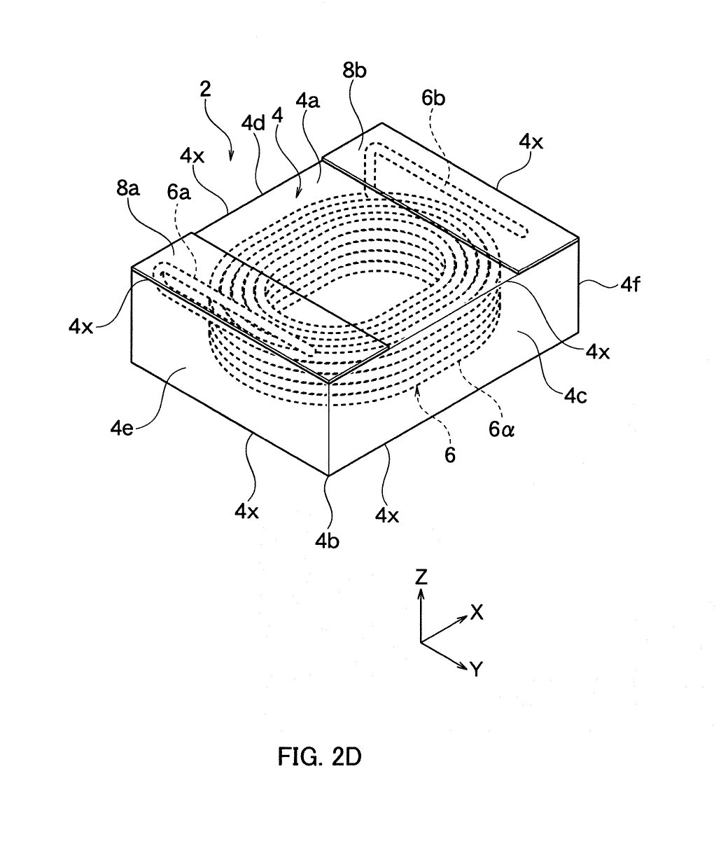

As shown in FIG. 2D, the component body 4 contains a wire 6 as a conductor wound in a coil shape. In the present embodiment, the wire 6 is preferably a wire covered with an insulation film. This is because even if the metal magnetic particles are dispersed in a main component constituting the component body 4, there is less risk of short circuit between a core wire and the metal magnetic particles of the component body 4, withstand voltage characteristics are improved, and deterioration of inductance is prevented.

In the present embodiment, for example, the wire 6 is formed by a round wire of a copper wire covered with an insulation film. This insulation film is an epoxy modified acrylic resin or so. Incidentally, the wire 6 may be a copper or silver wire covered with enamel, and may be a rectangular wire. The wire 6 is not limited to an insulated wire, and may be a wire that is not insulated. The wire 6 is not limited to a round wire, and may be a rectangular wire (flat wire), a square wire, or a litz wire. The core of the wire 6 is not limited to copper or silver, and may be an alloy containing them, another metal or alloy, or the like.

The wire 6 is wound in a coil shape by one or more turns (5×5 turns in the illustrated example) in the component body 4, and a coil portion 6a is thereby formed. In the present embodiment, the coil portion 6a is formed by an air-core coil where the wire 6 is wound by a-winding, but may be formed by an air-core coil where the wire 6 is wound by an ordinary normal wise or by an air-core coil where the wire 6 is wound by an edge wise.

A first lead 6a is formed at one end of the wire 6, and a second lead 6b is formed at the other end of the wire 6. In the illustrated example, the leads 6a and 6b extend toward the side surface 4c in the Y-axis direction. In the present embodiment, a part of the outer circumference of the first lead 6a of the wire 6 is exposed from one end of the mounting surface 4a in the X-axis direction (near side surface 4e), and a part of the outer circumference of the second lead 6b of the wire 6 is exposed from the other end of the mounting surface 4a in the X-axis direction (near side surface 4f).

From the viewpoint of reducing the height of the inductor 2, a part of the outer circumferences of the leads 6a and 6b is preferably exposed from the mounting surface 4a, but the whole of the outer circumferences of the leads 6a and 6b may be exposed from the mounting surface 4a.

As shown in FIG. 1A and FIG. 1B, a first terminal electrode 8a is formed on one end of the mounting surface 4a in the X-axis direction (near side surface 4e), and a second terminal electrode 8b is formed on the other end of the mounting surface 4a in the X-axis direction (near side surface 4f).

Unlike a normal electronic device where a terminal electrode is also formed on a side surface, the first terminal electrode 8a is formed only on the mounting surface 4a without covering the side surfaces 4c to 4e of the component body 4 in the present embodiment. The first terminal electrode 8a has an elongated shape in the Y-axis direction and covers the mounting surface 4a from one end of the mounting surface 4a in the Y-axis direction near the side surface 4c to the other end of the mounting surface 4a in the Y-axis direction near the side surface 4d. As shown in FIG. 2D, the first terminal electrode 8a covers a part of the outer circumference of the first lead 6a exposed from the mounting surface 4a and is electrically connected with the first lead 6a.

Likewise, unlike a normal electronic device where a terminal electrode is also formed on a side surface, the second terminal electrode 8b is formed only on the mounting surface 4a without covering the side surfaces 4b to 4d or 4f of the component body 4 in the present embodiment. The second terminal electrode 8b has an elongated shape in the Y-axis direction and covers the mounting surface 4a from one end of the mounting surface 4a in the Y-axis direction near the side surface 4c to the other end of the mounting surface 4a in the Y-axis direction near the side surface 4d. The second terminal electrode 8b covers a part of the outer circumference of the second lead 6b exposed from the mounting surface 4a and is electrically connected with the second lead 6b.

As shown in FIG. 1C, the terminal electrodes 8a and 8b function as a joint surface of solder with an electrode (land) of the circuit board 20.

As shown in FIG. 1A, the first terminal electrode 8a has a first edge 8a1 at one end of the first terminal electrode 8a in the Y-axis direction near the side surface 4c, a second edge 8a2 at the other end of the first terminal electrode 8a in the Y-axis direction near the side surface 4d, and a third edge 8a3 at one end of the first terminal electrode 8a in the X-axis direction near the side surface 4e.

In the present embodiment, as shown in FIG. 1D, the first edge 8a1 of the first terminal electrode 8a becomes thinner toward the chamfered part 4ac, and the second edge 8a2 of the first terminal electrode 8a becomes thinner toward the chamfered part 4ad. As shown in FIG. 1E, the third edge 8a3 of the first terminal electrode 8a becomes thinner toward the chamfered part 4ae. In the first terminal electrode 8a of the present embodiment, the ends of the edges 8a1, 8a2, and 8a3 are not formed on the chamfered parts 4ac, 4ad, or 4ae of the component body 4, but are formed on a flat part of the mounting surface 4a so as to contact with the chamfered parts 4ac, 4ad, and 4ae of the component body 4.

The second terminal electrode 8b has a first edge 8b1 at one end of the second terminal electrode 8b in the Y-axis direction near the side surface 4c, a second edge 8b2 at the other end of the second terminal electrode 8b in the Y-axis direction near the side surface 4d, and a third edge 8b3 at one end of the second terminal electrode 8b in the X-axis direction near the side surface 4f.

Although not illustrated, the first edge 8b1 of the second terminal electrode 8b becomes thinner toward the chamfered part 4ac shown in FIG. 1A, the second edge 8b2 of the second terminal electrode 8b becomes thinner toward the chamfered part 4ad, and the third edge 8b3 of the second terminal electrode 8b becomes thinner toward the chamfered part 4af. In the second terminal electrode 8b of the present embodiment, the ends of the edges 8b1, 8b2, and 8b3 are not formed on the chamfered parts 4ac, 4ad, or 4af of the component body 4, but are formed on a flat part of the mounting surface 4a so as to contact with the chamfered parts 4ac, 4ad, and 4af of the component body 4.

Preferably, the terminal electrodes 8a and 8b have a thickness of 10 to 100 μm or more. In this range, the edges 8a1 to 8a3 and 8b1 to 8b3 of the terminal electrodes 8a and 8b can gradually be thinner toward the chamfered parts 4ac to 4af. In the present embodiment, however, as mentioned below, the component body 4 with the terminal electrodes 8a and 8b is chamfered, and the terminal electrodes 8a and 8b are polished together. That is, the thicknesses of the terminal electrodes 8a and 8b are the thicknesses of the terminal electrodes 8a and 8b after the chamfering, and the thicknesses of the terminal electrodes 8a and 8b before the chamfering are larger than the thicknesses of the terminal electrodes 8a and 8b as shown by the one-dot chain lines in FIG. 1D and FIG. 1E.

As shown in FIG. 1B, a distance Ly1 between the edges 8a1 and 8b1 and the side surface 4c, a distance Ly2 between the edges 8a2 and 8b2 and the side surface 4d, a distance Lx1 between the edge 8a3 and the side surface 4e, and a distance Lx2 between the edge 8b3 and the side surface 4f depend upon how large the chamfered parts 4ac to 4af are, and are preferably 0.03 to 0.20 mm.

The terminal electrodes 8a and 8b are formed by a multilayer electrode film of a base electrode film and a plating film, for example. The plating film may be formed on the base electrode film constituted by a conductive paste film containing a metal of Sn, Ag, Ni, C, etc. or an alloy of these metals. In this case, the plating film is formed after the base electrode film is formed and thereafter subjected to a dry treatment or a heat treatment. For example, the plating film is a metal of Sn, Au, Ni, Pt, Ag, Pd, etc. or an alloy of these metals. Incidentally, the terminal electrodes 8a and 8b may be formed by sputtering.

Next, described is a method of manufacturing the inductor 2 of the present embodiment. In the method of the present embodiment, initially prepared are a molding die with cavities and a plurality (16 in the present embodiment) of wires 6 (coil portions 6a) wound in air-core coil.

The wires 6 (coil portions 6α) are embedded in the molding die (embedding step), and a pressed powder molding is carried out so that at least a part of the outer circumferences of the leads 6a and 6b is exposed from one of the surfaces of the substrate 10 as shown in FIG. 2A. The pressed powder molding is carried out in such a manner that a synthetic resin in a molten state where metal magnetic particles are dispersed is poured into the molding die containing the wires 6 and is cured by, for example, heat.

In the embedding step, the leads 6a and 6b of each wire 6 are aligned to extend in the Y-axis direction. The wires 6 are arranged in lattice so that the intervals between the wires 6 (coil portions 6α) adjacent to each other in the X-axis direction and the intervals between the wires 6 (coil portions 6α) adjacent to each other in the Y-axis direction are approximately equal to each other. Incidentally, the leads 6a and 6b of each wire 6 can be formed by bending the ends of the wire 6 drawn from the coil portion 6a toward the opposite direction to the drawn direction by about 180°.

Obtained is a substrate (molded body) 10 containing the plurality of wires 6 so that at least a part of the leads 6a and 6b is exposed. Incidentally, this method is not the only one method of obtaining the substrate 10 containing the plurality of wires 6. For example, the substrate 10 may be obtained by preparing two magnetic substrates, arranging the wires 6 in lattice on one of the magnetic substrates (lower magnetic substrate), covering them with the other magnetic substrate (upper magnetic substrate) from above, and integrating the magnetic substrates.

Next, as shown in FIG. 2B, a plurality (five in the illustrate example) of terminal electrode patterns 8 is formed on one of the surfaces of the substrate 10 containing the wires 6 by a paste method and/or a plating method, and is subjected to a dry treatment or a heat treatment as necessary (terminal-electrode formation step). From the viewpoint of easy manufacture, the terminal electrode patterns 8 are preferably formed by a screen printing using a silver paste.

Preferably, the terminal electrode patterns (silver paste or so) 8 are formed even on boundaries with the side surfaces of the substrate 10. Incidentally, even if the terminal electrodes protrude on the side surfaces of the substrate 10, these protrusions can be removed by a barrel polishing mentioned below.

In the terminal-electrode formation step, the terminal electrode patterns 8 are formed on one of the surfaces of the substrate 10 so as to cover even near the side surfaces of the substrate 10 (from the corner at one of the ends of the substrate 10 in the Y-axis direction to the corner at the other end of the substrate 10 in the Y-axis direction) and so as to be connected with a part of the outer circumferences of the leads 6a and 6b of the wire 6 exposed from one of the surfaces of the substrate 10. In the example of FIG. 2B, the terminal electrode patterns 8 continuously cover the substrate 10 from the corner at one of the ends of the substrate 10 in the Y-axis direction to the corner at the other end of the substrate 10 in the Y-axis direction, but may intermittently cover the substrate 10.

The terminal electrode patterns 8 are formed slenderly on the substrate 10 in the Y-axis direction so that the first lead 6a of the wire 6 in each line and the second lead 6b of the wire 6 in each line adjacent to each line of the first lead 6a of the wire 6 in the X-axis direction are covered with the single terminal electrode pattern 8. The terminal electrode pattern 8 is polished and becomes thinner in the barrel polishing mentioned below, and is thereby formed to be thick in advance by the amount to be polished.

Next, as shown in FIG. 2C, the substrate 10 with the terminal electrode patterns 8 is cut along cut-scheduled lines 10A extending in the X-axis direction and cut-scheduled lines 10B (terminal electrode patterns 8) extending in the Y-axis direction, and is divided into 16 pieces (cut step). As a result, the component body 4 containing the single wire 6 is obtained as shown in FIG. 2D. The substrate 10 is cut by any method, such as cutting tools of dicing saws, wire saws, or the like and laser. From the viewpoint of easy cut, a dicing saw having a sharp cut surface is preferably used.

Next, the component body 4 obtained is subjected to a barrel polishing (barrel polishing step). For example, the barrel polishing is carried out using a centrifugal barrel device having a rotatable barrel vessel. Incidentally, the polishing can be dry type or wet type, but a wet type barrel polishing is preferable.

In the barrel polishing step, polished are the portion shown by the two-dot chain lines of FIG. 1E (component body before polishing) and the portion shown by the one-dot chain line of FIG. 1E (terminal electrode before polishing). As a result, the chamfered parts 4ac to 4af and 4bc to 4bf shown in FIG. 1A are formed at intersections 4× between the mounting surface 4a (surface corresponding to one of the surfaces of the substrate 10 mentioned above) and the side surfaces 4c to 4f and at intersections 4× between the rear surface 4b opposite to the mounting surface 4a and the side surface 4c to 4f.

In the barrel polishing step, the terminal electrodes 8a and 8b are polished together with the component body 4. Thus, as shown in FIG. 1D and FIG. 1E, the edges 8a1 to 8a3 and 8b1 to 8b3 of the terminal electrodes 8a and 8b after the polishing (see the solid lines) are thinner than the edges 8a1 to 8a3 and 8b1 to 8b3 of the terminal electrodes 8a and 8b before the polishing (see the one-dot chain lines), and become thinner toward the chamfered parts 4ac, 4ad, and 4ae. The portion other than the edges 8a1 to 8a3 and 8b1 to 8b3 of the terminal electrodes 8a and 8b after the polishing (see the solid lines) is uniformly thinner by a predetermined amount than the edges 8a1 to 8a3 and 8b1 to 8b3 of the terminal electrodes 8a and 8b before the polishing (see the one-dot chain lines).

In the barrel polishing, a polishing speed (R-formation speed) at the intersections 4× of the component body 4 shown in FIG. 2D is normally larger than film reduction speeds of the terminal electrodes 8a and 8b. The polishing speed is appropriately controllable using media for barrel polishing (spherical media).

In the above-mentioned method, the edges 8a1 to 8a3 and 8b1 to 8b3 of the terminal electrodes 8a and 8b are chamfered together with the intersections 4× between one of the surfaces and the side surfaces of the cut substrate 20 in forming the chamfered parts 4ac to 4af and 4bc to 4bf. Thus, it is possible to easily manufacture an aggregation of an inductor 2 where the edges 8a1 to 8a3 and 8b1 to 8b3 of the terminal electrodes 8a and 8b gradually become thinner toward the chamfered parts 4ac to 4af (toward the side surfaces 4c to 4f).

The terminal electrode patterns 8 do not attach to each cut surface of the aggregation of the inductor 2, and it is possible to manufacture the inductor 2 with the terminal electrodes 8a and 8b formed only on the mounting surface 4a.

In the above-mentioned method, the steps are carried out in the order of the terminal-electrode formation step, the cut step, and the barrel polishing step after obtaining the substrate (molded body) 10 containing a plurality of wires 6, but the steps may be carried out in the order of the cut step, the terminal-electrode formation step, and the barrel polishing step.

That is, the cut step is carried out after obtaining the substrate (molded body) 10 containing a plurality of wires 6, and the component bodies 4 containing a single wire 6 are obtained so that at least a part of the leads 6a and 6b is exposed. Next, the terminal-electrode formation step is carried out for the component bodies 4 (pieces of the inductor 2) containing a single wire 6.

In the terminal-electrode formation step, the terminal electrodes 8a and 8b are formed on the mounting surface 4a of the component body 4 containing a single wire 6 by a paste method and/or a plating method, and are subjected to a dry treatment or a heat treatment as necessary. At this time, the terminal electrodes 8a and 8b are formed on the mounting surface 4a of the component body 4 so as to cover even boundaries with the side surfaces 4c and 4d of the component body 4 (from the corner at one of the ends of the component body 4 in the Y-axis direction to the corner at the other end of the component body 4 in the Y-axis direction) and so as to be connected with a part of the outer circumferences of the leads 6a and 6b of the wire 6 exposed from one of the surfaces of the component body 4.

Next, the component bodies 4 obtained are subjected to the above-mentioned barrel polishing step, and pieces of the inductor 2 are obtained.

According to the above-mentioned method, the edges 8a1 to 8a3 and 8b1 to 8b3 of the terminal electrodes 8a and 8b are chamfered together with the intersections between the mounting surface 4a and the side surfaces 4c to 4f of the component body 4 in forming the chamfered parts 4ac to 4af. Thus, it is possible to easily manufacture the pieces of the inductor 2 where the edges 8a1 to 8a3 and 8b1 to 8b3 of the terminal electrodes 8a and 8b become gradually thinner toward the chamfered parts 4ac to 4af and 4bc to 4bf (toward the side surfaces 4c to 4f).

In the inductor 2 according to the present embodiment, the chamfered parts 4ac to 4af are formed at the intersections between the mounting surface 4a and the side surfaces 4b to 4f of the component body 4, and the edges 8a1 to 8a3 and 8b1 to 8b3 of the terminal electrodes 8a and 8b become thinner toward the chamfered parts 4ac to 4af. That is, the edges 8a1 to 8a3 and 8b1 to 8b3 of the terminal electrodes 8a and 8b are chamfered integrally with the intersections between the mounting surface 4a and the side surfaces 4b to 4f of the component body 4 in forming the chamfered parts 4ac to 4af in the present embodiment. Thus, the edges 8a1 to 8a3 and 8b1 to 8b3 of the terminal electrodes 8a and 8b are arranged inside the side surfaces 4b to 4f of the component body 4 and are smoothly (continuously) connected with the chamfered surfaces of the chamfered parts 4ac to 4af while being gently curved. During high-density mounting, it thereby becomes harder for solder to protrude outward from the component body 4 and to reach between the inductors 2 adjacent to each other, compared to prior arts. Thus, it is possible to effectively prevent generation of solder bridge between the terminal electrodes 8a and 8b adjacent to each other and to effectively prevent generation of short circuit failure between the terminal electrodes 8a and 8b adjacent to each other. Since the edges 8a1 to 8a3 and 8b1 to 8b3 of the terminal electrodes 8a and 8b reach near the chamfered parts 4ac to 4af, it is possible to secure sufficient areas of the terminal electrodes 8a and 8b and to secure an excellent mounting strength even if a chip size is small.

Incidentally, the present invention is not limited to the above-mentioned embodiment, and may be changed variously within the scope of the present invention.

The above-mentioned embodiment illustrates that the edges 8a1 to 8a3 and 8b1 to 8b3 of the terminal electrodes 8a and 8b become thinner toward the chamfered parts 4ac to 4af as shown in FIG. 1A, but the edges 8a1 to 8a3 and 8b1 to 8b3 are not limited to this structure. In the example of FIG. 1F, for example, only edges 108a2, 108a3, 108b1, and 108b3 among edges 108a1 to 108a3 and 108b1 to 108b3 of terminal electrodes 108a and 108b are formed to become thinner toward the chamfered parts 4ac to 4af, but the edges 108a1 and 108b2 are not formed to become thinner toward the chamfered parts 4ac and 4af.

That is, any of the edges 8a1 to 8a3 and 8b1 to 8b3 of the terminal electrodes 8a and 8b may become thinner toward the chamfered parts 4ac and 4ad.

The above-mentioned embodiment describes a method of manufacturing the inductor 2, but if the electronic device according to the present invention is another electronic device of a capacitor, a resistor, or the like, the substrate 10 or the component body 4 where an element of this electronic device is embedded (contained) is subjected to the above-mentioned steps (cut step, terminal-electrode formation step, barrel polishing step, etc.).

The wires 6 have a winding shape of elliptical spiral in the above-mentioned embodiment, but the wires 6 may have a winding shape of circular spiral, square spiral, concentric circle, or the like.

### NUMERICAL REFERENCES

2, 102 . . . inductor (coil device)
   4 . . . component body
      4ac, 4ad, 4ae, 4af, 4bc, 4bd, 4be, 4bf . . . chamfered part
   6 . . . wire
      6α . . . coil portion
6a, 6b . . . lead end
   8, 8a, 8b, 108a, 108b . . . terminal electrode
      8a1, 8a2, 8a3, 8b1, 8b2, 8b3, 108a1, 108a2, 108a3, 108b1, 108b2, 108b3 . . . edge
   10 . . . substrate
   10A, 10B . . . cut-scheduled line
   20 . . . circuit board

1. An electronic device, comprising:
a component body; and
a terminal electrode formed on a mounting surface of the component body,
wherein a chamfered part is formed at an intersection between the mounting surface and a side surface of the component body, and
wherein an edge of the terminal electrode becomes thinner toward the chamfered part.

2. The electronic device according to claim 1, wherein the chamfered part is formed by an R-plane or a C-plane.

3. An electronic device, comprising:
a component body containing an element; and
a terminal electrode formed on a mounting surface of the component body,
wherein a chamfered part is formed at an intersection between the mounting surface and a side surface of the component body,
wherein the element is connected with the terminal electrode, and
wherein an edge of the terminal electrode becomes thinner toward the chamfered part.

4. The electronic device according to claim 3, wherein the chamfered part is formed by an R-plane or a C-plane.

5. The electronic device according to claim 3, wherein the edge of the terminal electrode is continuously connected with a chamfered surface of the chamfered part.

6. The electronic device according to claim 4, wherein the edge of the terminal electrode is continuously connected with a chamfered surface of the chamfered part.
